(19) United States
(12) Patent Application Publication
(10) Pub. No.: US 2008/0025366 A1
(43) Pub. Date: Jan. 31, 2008

(54) Probe for Measuring Thermal and Hydraulic Properties

(76) Inventor: Terence McBurney, Ledbury (GB)

Correspondence Address: YOUNG & THOMPSON, 745 SOUTH 23RD STREET, 2ND FLOOR, ARLINGTON, VA, 22202, US

(21) Appl. No.: 10/554,512

(22) PCT Filed: Apr. 28, 2004
(86) PCT No.: PCT/GB04/01810

§ 371 Date: Jun. 19, 2006

(30) Foreign Application Priority Data
Apr. 29, 2003 (GB) 0309656.7

(51) Int. Cl. G01D 21/00; H01S 4/00

(52) U.S. Cl. 374/44; 29/592.1; 73/866.5

(57) ABSTRACT

A probe (10) includes a base element (12), formed from an inflexible material and having one or more unitary rigid elongate prong members (18), heating and sensing elements (20) and (22) supported on the base element (12), and elements for electrically energizing at least the heating element (20). The heating element (20) is formed on the or one prong member (18) so that, when energized, the thermal energy output by the heating element (20) can be sensed by the sensing element (22) to determine at least the thermal conductivity of a substance in which the probe (10) is inserted.

The present invention relates to a probe for measuring thermal and hydraulic properties of a substance.

Measurements of, amongst other things, specific heat capacity, thermal conductivity, thermal diffusivity, and heat capacitance are required for predicting rates of heating and cooling of, for example, food substances and soil. These values are taken into account when designing systems, such as food processing systems, and improving irrigation management in crops and sports or amenity turf.

Standard measurement techniques are well-known. Calorimetry can be used to determine specific heat, and hot-plate measurement can be used to determine thermal conductivity of a substance. However, these have long equilibration times and other shortcomings such as bulky apparatus and, as such, only highly specialised physical laboratories can be considered to offer reliable measurements. Therefore, to enable real-time on-line, or rapid off-line, measurements, wire probes that use known line heat source techniques have been developed.

A problem with wire probes is that the wire prong member or members, which are typically thin hollow tubes or needles, can easily become bent. This, in the case of multi-pronged probes where the spacing between the prongs is critical to accuracy, then becomes the major source of error.

The present invention seeks to provide a solution to this problem.

According to a first aspect of the present invention, there is provided a probe for measuring thermal and hydraulic properties of a substance, the probe comprising a base element, formed from an inflexible material and having one or more unitary rigid elongate prong members, heating and sensing elements, and means for electrically energising at least the heating element, the heating element being formed on the or one prong member so that, when energised, the thermal energy output by the heating element can be sensed by the sensing element to determine at least the thermal conductivity of the substance.

Preferable and/or optional features of the first aspect of the invention are set forth in claims 2 to 17, inclusive.

According to a second aspect of the present invention, there is provided a method of manufacturing a probe in accordance with the first aspect of the invention, the method comprising the steps of:
a) determining the number of prong members required,
b) preparing the base element material,
c) film depositing the heating and sensing elements on to the base element material, and
d) cutting or stamping out the probe from the base element material.

Preferable and/or optional features of the second aspect of the invention are set forth in claims 19 to 23, inclusive.

The present invention will now be described, by way of example only, with reference to the accompanying drawings, wherein:

FIG. 1 is a diagrammatic perspective view of a first embodiment of a probe, in accordance with the first aspect of the present invention;

FIG. 2 is a circuit diagram of a heating circuit of the probe;

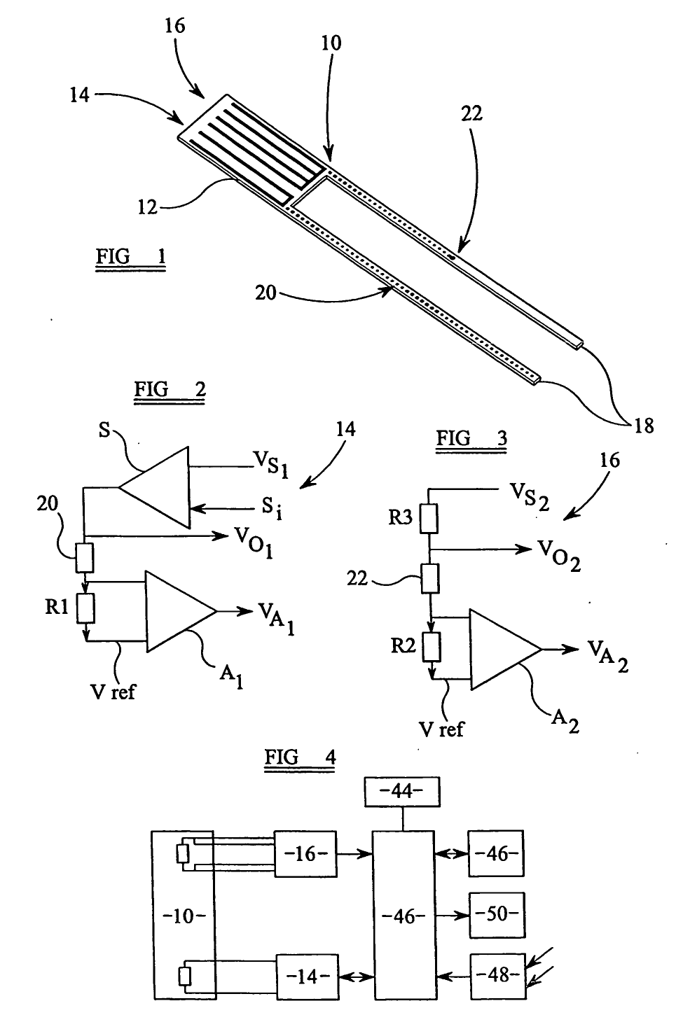

FIG. 3 is a circuit diagram of a sensing circuit of the probe;

FIG. 4 is a circuit diagram of a system incorporating the probe, heating circuit and sensing circuit;

FIG. 5 is a diagrammatic perspective view of a second embodiment of a probe, in accordance with the first aspect of the present invention;

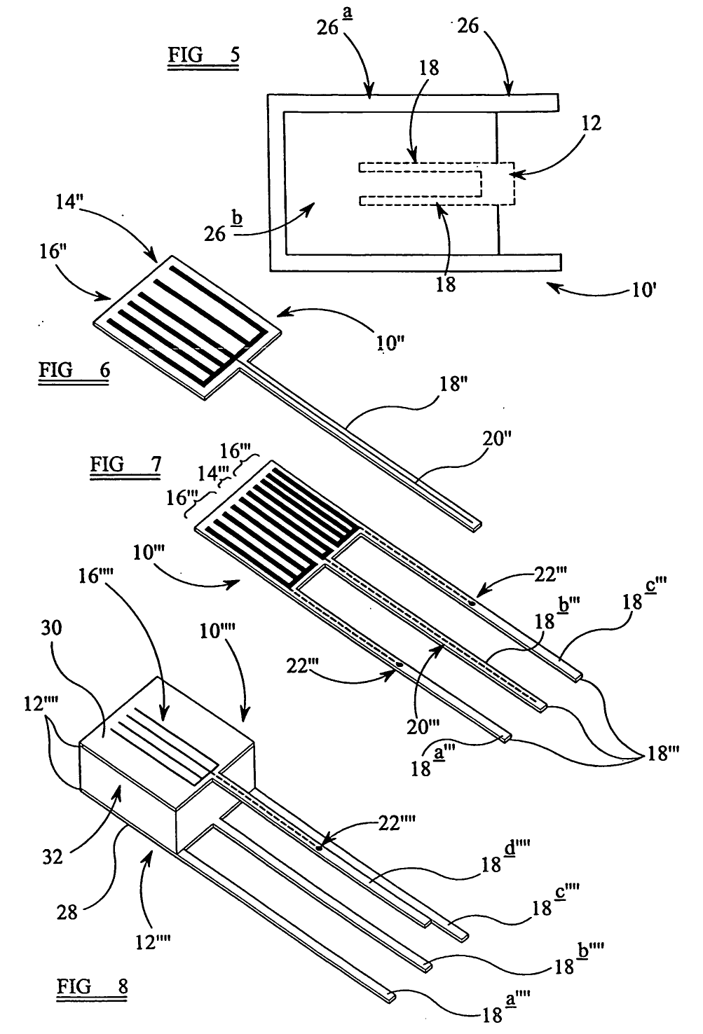

FIG. 6 is a diagrammatic perspective view of a third embodiment of a probe, in accordance with the first aspect of the present invention;

FIG. 7 is a diagrammatic perspective view of a fourth embodiment of a probe, in accordance with the first aspect of the present invention; and

FIG. 8 is a diagrammatic perspective view of a fifth embodiment of a probe, in accordance with the first aspect of the present invention.

Referring to FIGS. 1 to 4, there is shown a probe 10 which comprises a base element 12, an electrical heating element 20 of a heating circuit 14 and a sensing element 22 of an active sensing circuit 16. The heating element 20 and the sensing element 22 are independently supported on the base element 12. Means for electrically energising the heating and sensing circuits 14 and 16, and means for monitoring the output of the sensing circuit 16 are also provided, typically remote from the probe 10.

The base element 12 is a plate-type substrate formed from a rigid inflexible material, such as alumina ceramic, aluminium nitride or silicon, and has two unitary elongate prong members 18.

The heating element 20 of the heating circuit 14 is a thin-film platinum resistive heating element which extends along the entire or substantially entire longitudinal extent of one of the prong members 18. The heating circuit 14 is a two junction device (see FIG. 2), capable of dissipating 5 Watts, which is connectable to the energisation means (as shown) via two bonding, typically solder, pads (not shown).

The temperature sensing element 22 of the sensing circuit 16 is a resistance temperature device (RTD) which is positioned halfway, or substantially halfway, along the longitudinal extent of the other prong member 18. The RTD 22 is a four junction device having four lead connections (see FIG. 3) which is connectable to the energisation means via four bonding, typically solder, pads (not shown). In this way, the resistances of the leads will have little or no effect on the system accuracy.

The energisation means includes a power source 44, typically 12 to 20 volt regulated, which is electrically connected to the heating circuit 14 and the sensing circuit 16 within a system 40 (as shown in FIG. 4). The system 40 is based around a microcontroller 42, which is programmed to control the separate functions of the system 40. The microcontroller 42 has an analogue-to-digital (A/D) converter (not shown) that enables the input voltage to be compared with a voltage reference source (not shown in FIG. 4). Separate devices could also be used for the A/D converter and voltage reference sources providing higher resolution. The RTD temperature sensor 22 gives an output voltage in proportion to the temperature. There are many ways of measuring the resistance such as a dedicated integrated circuit, a constant current source, or a lower-cost system that supplies a voltage to the RTD and measures the current passing through it (such as shown in FIG. 3). In the last case, two voltages V_{A2} and V_{O2} will be measured by the microcontroller 42. In FIG. 3, V_{S2} is a voltage source from power supply 44, R3 is a resistor, and V_{ref} is a reference voltage, and may be ground. V_{A2} is output from amplifier A₂ and represents the current through the RTD 22, and V_{O2} is the applied voltage. V_{A2} is linearly proportional to the temperature of the sensing element 22, and V_{O2}+V_{A2} enables the microcontroller 42 to determine the temperature sensed by the RTD 22. A reference resistor R2 limits the current through the RTD 22 and ensures the voltage measured by the microcontroller 42 is below any reference voltage it uses.

The heating element 20 supplies a known quantity of heat. A voltage source V_{S1} from power source 44 is switched on and off, by a switch S controlled by a pulsed input Sᵢ, at a rate determined by the requirements of the system 40. The current through the heating element 20 is monitored by the voltage across resistor R1. Similarly to above, V_{A1} is output from amplifier A₁ and represents the current passing through the heating element 20, and V_{O1} is the applied voltage. V_{A1}+V_{O1} gives an indication of the energy of the heat pulse from the heating element 20. Supply voltage V_{S1} to the heating element 20 is also monitored by the microcontroller 42. The microcontroller 42 is programmed to multiply the voltage V_{S1} by the current to produce an energy input value. The input pulse Sᵢ is then modulated to produce the required input energy.

The power source 44 of the system 40 will usually be a battery. The power requirement will depend mainly on the heat dissipated by the heater and its duty cycle.

The temperature sensor 22 of the sensing circuit 16 can be calibrated prior to use in any suitable known way. For example, the temperature sensor 22 can be calibrated over the range of 0° to 60° C. by attaching the probe 10 together with a known type-K thermocouple, such as Calex Instruments STC-TT-36-36-SMP, to a copper plate (not shown), typically of 100 mm×100 mm×1 mm, using heat-sink compound, and then slowly varying the ambient temperature.

The system 40 is a monitoring system, and may be arranged as shown in FIG. 4. The system 40 comprises the microcontroller 42 and a memory device 46, such as an external Flash or EEPROM memory storage device, to store the results of measurements. It is also possible to use the internal processor memory if the number of results is not too great. There are several methods of implementing the monitoring. In one method the microcontroller 42 wakes up after a set period of time and starts a programmed set of heat pulse and measurement cycles. Measured data is stored in the memory device 46. Upon receipt by a receiver 48 of the system 40 of a download request from a readout device (such as a hand-held computer, which is not shown) the data is read out of memory 46 and transmitted via a communications interface 50 to the computer. The communications interface 50 may be a physical connection via a wire, an infra-red transmitter or a radio transmitter. The system 40 shown in FIG. 4 illustrates a bi-directional radio transmitter/receiver that facilitates both download request and data transmission. There are several radio communication technologies available to implement such as system.

To manufacture the probe 10, a thin-film photolithography process is used. A tile of suitable base element material, having purity and surface polish suitable for high quality uniform platinum deposition, is first acquired. The base element material is prepared by use of a wet chemical cleaning process and then dehydration baking to remove any excess solvent. The number of prong members required, in this case two, is determined. A suitable photolithographic, typically glass-chrome, mask of the heating and sensing circuits is then formed. A photo-resist coating is applied evenly to the base element material, and is exposed to ultra-violet light through the mask to develop areas of the photo-resist for metalisation. Light plasma cleaning is then undertaken, followed by platinum vapour deposition of the heating and sensing elements using thermal evaporation. Lift-off of the photo-resist coating under the deposited platinum film is performed using solvent, typically acetone, leaving only the platinum film which has been directly deposited onto the base element material. The heating and sensing elements are post-cleaned to remove sidewalls and burrs. The probe is laser-cut to shape from the tile of base element material so that the prong members are parallel and set at a precise fixed immovable distance apart. Finally all surfaces of the probe are electrically insulated using a conformational coat such as silicone.

In use, for measurement of thermal properties, the probe 10 is inserted into a substance to be tested. The heating element 20 of the heating circuit 14 can either be periodically energised to emit heat pulses, or continuously energised for a given duration, through use of the switch S. The RTD 22 of the energised sensing circuit 16 determines the change in temperature and outputs a suitable signal which is periodically sampled by the monitoring means. This data can then be fed into appropriate known mathematical models stored in the computer and the results can be graphically represented and printed out from the computer, or simply tabulated. From the mathematical models, the heat capacity, thermal conductivity, and/or thermal diffusivity of the substance can be determined.

Referring to FIG. 5, a second embodiment of the probe 10′ is shown therein. This probe 10′ utilises the two prong members 18 of the probe 10 of the first embodiment but, once formed, is then encapsulated in porous ceramic material 26.

The encapsulation takes the form of a fired outer ceramic vessel 26a in which the probe 10′ is positioned and surrounded by porous ceramic packing 26b.

Encapsulation in this manner is particularly useful for a probe utilised for measuring the moisture content of soil. The porous ceramic material 26 holds moisture by surface tension in equilibrium with the surrounding soil moisture. This moisture varies with soil moisture content, thus inducing a measurable change in the heat capacitance of the soil.

By encapsulation, the heat capacitance is defined by a heat pulse peak height, monitored and output by the sensing circuit 16, and a sensor constant. This eliminates the need for logging sequential readings and fitting complex mathematical models. Probes 10′ can thus be factory calibrated against soil water potential (or moisture tension), which directly relates to the extractability of soil moisture by roots of plants and which is independent of soil type.

Referring to FIG. 6, a third embodiment of the probe 10″ is shown. This probe 10″ utilises only one prong member 18″ which is formed as part of the plate-type substrate, similar to the first embodiment. In this case, the heating and sensing elements 20″ and 22″ of the heating and sensing circuits 14″ and 16″ are combined and supported on the single prong member 18″.

In use, the heating element 20″ of the heating circuit 14″ is energised for a given time, and the sensing circuit 16″ monitors the rate of cooling. The single prong probe 10″ is thus useful where only the thermal conductivity of the substance is required.

FIG. 7 shows a fourth embodiment of the probe 10′″. This probe 10′″ is formed from a plate-type substrate, similar to the first embodiment, but has three equi-distantly spaced prong members 18′″. Sensing circuits 16′″ have an RTD 22′″ on each outer prong member 18′″, respectively, and the heating element 20′″ of the heating circuit 14′″ is supported on the middle prong member 18b′″ interposed between the two outer prong members 18a′″ and 18c′″.

This arrangement additionally allows the hydraulic conductivity and/or perpendicular water flow rate characteristic of the substance in which the probe 10′″ is inserted to be determined by measuring the different temperature traces at each prong that occur under conditions of water flux and applying a mathematical model.

FIG. 8 shows a fifth embodiment of the probe 10″″. In this case, the base element 12″″ is a block-type substrate. A first surface 28 of the block-type substrate includes first, second and third elongate prong members 18a″″, 18b″″ and 18c″″, similar to that of the fourth embodiment, which are spaced equi-distantly from each other. A second surface 30 of the block-type substrate, which is spaced from, and parallel to, the first surface 28, includes a fourth prong member 18d″″, similar to that of the third embodiment. All the prong members 18a″″ to 18d″″ are oriented in the same direction and are parallel to each other. The depth of the block-type substrate is such that the fourth prong member 18d″″ is spaced from the second prong member 18b″″ by the same distance that the first and third prong members 18a″″ and 18b″″ are spaced from the second prong member 18b″″.

Sensing circuits 16″″ have an RTD 22″″ supported on outwardly facing portions of the first, third and fourth prong members 18a″″, 18c″″ and 18d″″. The heating element of the heating circuit (not seen in FIG. 8) is supported on an outwardly facing portion of the second prong member 18b″″, interposed between the first and third prong members 18a″″ and 18c″″.

By this arrangement, the water flow rate characteristic of the substance in which the probe 10″″ is inserted can be more accurately determined by allowing account to be taken of non-perpendicular flow to the sensor. Furthermore, when the substance is a liquid, thermal properties can be ascertained, due to the prong members 18a″″ to 18d″″ being positioned in two spaced parallel planes, by the convective currents generated by the heat energy output from the heating element.

The block-type substrate is formed from two plate-type substrates 12″″ fixed to a spacer element 32. The spacer element 32 is either formed from plastics or ceramics material. However, the block-type substrate could be formed from a single unitary element, such as a single piece of alumina ceramic.

In a modification to the above-described embodiments, the probe could be formed with an array of prong members. This would enable a gradation in heat capacity, thermal conductivity, thermal diffusivity, hydraulic conductivity, water flow rate characteristic, and/or thermal properties of the substance to be determined.

The heating and sensing circuits could be entirely formed on the probe.

When forming all or parts of the heating and sensing circuits on the probe, other types of thin-film deposition processes could be used instead of photolithography, such as an electron-beam lithography process, or an X-ray lithography process, and any other suitable thin-film metalisation process could be used instead of vapour deposition, such as a sputtering process or an electro-plating process.

Alternatively, a suitable thick-film deposition process could be used, such as a screen-printing process.

Furthermore, other types of metals, as alternatives to platinum, could be used to form the heating and sensing circuits, such as tungsten or palladium.

The RTD of the sensing circuit could be a two or three junction device but in these cases the resistances of the aforementioned leads may affect the accuracy of the temperature measurements. Also, the sensing circuit could be a passive sensing circuit. In this case, the temperature sensing element would be, for example, a passive thermocouple element.

Where a plurality of sensing circuits are utilised, these could be combined to form a single sensing circuit having multiple temperature sensing elements.

Instead of laser-cutting, the probe could be stamped from the tile of base element material. Instead of thin film heating and temperature sensing elements, a thick-film process could be used which would be cheaper to manufacture but incur penalties from reduced accuracy.

Further economies can also be achieved by using a thick-film process directly onto a porous ceramic substrate, insulated by a dielectric layer made of a polymer, thereby eliminating the laser cutting or stamping process steps.

By the use of rigid inflexible materials, it is possible to provide a probe, having prong members, which can be precisely manufactured, has excellent structural resilience, and exhibits desirable thermal characteristics, such as high thermal conductivity and low specific heat capacity. This results in the data obtained during repeated use of the probe being of a higher degree of accuracy and, consequently, more reliable. Since the material is inflexible, the prong members fracture and break rather than bending.

The embodiments described above are given by way of example only and further modifications will be apparent to persons skilled in the art without departing from the scope of the invention as defined by the appended claims. For example, an RTD is only one type of temperature sensing element, and other types of temperature sensor could be used.

1-24. (canceled)

25. A probe for measuring thermal and hydraulic properties of a substance, the probe comprising a base element, formed from an inflexible material and having one or more unitary rigid elongate prong members, heating and sensing elements, and means for electrically energising at least the heating element, the heating element being formed on the or one prong member so that, when energised, the thermal energy output by the heating element can be sensed by the sensing element to determine at least the thermal conductivity of the substance.

26. A probe as claimed in claim 25, wherein, when the base element has only a single prong member, the base element is a plate-type substrate and the heating and sensing elements are combined.

27. A probe as claimed in claim 25, wherein the base element is a plate-type substrate and has two of the said elongate prong members spaced by a fixed distance, the heating element being formed on one of the prong members and the sensing element being formed on the remaining prong member so that the heat capacity, thermal conductivity and/or thermal diffusivity of the substance can be determined.

28. A probe as claimed in claim 25, wherein the base element is a plate-type substrate and has three equi-distantly spaced said elongate prong members, two said sensing elements being supported on the two outer prong members, respectively, and the heating element being supported on the prong member interposed therebetween so that the heat capacity, thermal conductivity, thermal diffusivity, hydraulic conductivity, and/or water flow rate characteristic of the substance can be determined.

29. A probe as claimed in claim 25, wherein the base element is a block-type substrate and has first, second and third equi-distantly spaced said elongate prong members formed in a first surface of the base element and a fourth said elongate prong member formed in a second surface of the base element and spaced from the second prong member by the same distance that the first and third prong members are spaced from the second prong member, the first and second surfaces being spaced and parallel to each other and the prong members being oriented in the same direction, three said sensing elements being supported on the first and third outer prong members and on the fourth prong member, respectively, and the heating element being supported on the second prong member interposed between the first and third prong members, so that the heat capacity, thermal conductivity, thermal diffusivity, hydraulic conductivity, and/or water flow rate characteristic of the substance can be determined.

30. A probe as claimed in claim 29, wherein the block-type substrate is formed from two plate-type substrates fixed to a spacer element.

31. A probe as claimed in claim 25, wherein the base element has an array of the said prong members so that a gradation in the heat capacity, thermal conductivity, thermal diffusivity, hydraulic conductivity, and/or the water flow rate characteristic of the substance can be obtained.

32. A probe as claimed in claim 25, wherein the base element is formed from one of ceramics, aluminum nitride, and silicon.

33. A probe as claimed in claim 25, wherein the heating element is formed from one of platinum, tungsten, and palladium.

34. A probe as claimed in claim 25, wherein the heating element extends along the entire or substantially entire length of the associated prong member.

35. A probe as claimed in claim 25, wherein the sensing element is in the form of a resistance temperature device (RTD).

36. A probe as claimed in claim 25, wherein the probe is encapsulated in porous ceramic.

37. A method of manufacturing a probe for measuring thermal and hydraulic properties of a substance, the method comprising the steps of:
a) determining a number of unitary rigid elongate prong members required,
b) preparing an inflexible material which forms a base element and the or each prong of the probe,
c) film depositing heating and sensing elements on to the inflexible base element material, and
d) cutting or stamping out the probe from the inflexible base element material, so that the heating element is solely or in part positioned on the or one prong member.

38. A method as claimed in claim 37, wherein the film deposition in step (c) is one of a thin-film deposition process and a thick-film deposition process.

39. A method as claimed in claim 38, wherein the thin-film deposition process is one of a photolithography process, an electron-beam lithography process, and an X-ray lithography process.

40. A method as claimed in claim 39, wherein the photolithography process comprises the steps of:
i) selecting a mask with the number of prongs selected in step (a) of claim 13,
ii) applying a photo-resist coating to the prepared inflexible base element material,
iii) exposing the photo-resist coating to ultra-violet radiation through the mask to develop the photo-resist coating,
iv) cleaning the developed photo-resist coating,
v) vapour depositing the sensing and heating elements, and
vi) lifting off the mask and post-cleaning the deposited sensing and heating elements.

41. A method as claimed in claim 40, wherein the mask of step (i) is a photolithographic glass-chrome mask.

42. A method as claimed in claim 37, further comprising a step (e) subsequent to step (d) of encapsulating the probe in porous ceramic material.
